(19) United States
(12) Patent Application Publication
(10) Pub. No.: US 2019/0293484 A1
(43) Pub. Date: Sep. 26, 2019

(54) ELECTRONIC DEVICE AND MANUFACTURING METHOD FOR ELECTRONIC DEVICE

(71) Applicant: GUANGDONG OPPO MOBILE TELECOMMUNICATIONS CORP., LTD., DONGGUAN (CN)

(72) Inventor: Haiping ZHANG, DONGGUAN (CN)

(21) Appl. No.: 16/186,889

(22) Filed: Nov. 12, 2018

(30) Foreign Application Priority Data
Mar. 21, 2018 (CN) 201810234679.9

(51) Int. Cl. G01J 1/02; G01J 1/42; G01J 1/04; G01C 3/08; G01V 8/12

(52) U.S. Cl. CPC G01J 1/0204; G01J 1/4204; G01V 8/12; G01C 3/08; G01J 1/0407

(57) ABSTRACT

The present disclosure provides an electronic device and a manufacturing method thereof. The electronic device includes: a display screen, the display screen including a display area and a non-display area surrounding the display area; a light sensor arranged below the display area; and a light guiding element arranged below the display screen, the light guiding element being configured to transmit light penetrating the non-display area to the light sensor.

### CROSS-REFERENCE TO RELATED APPLICATION

The application claims priority to Chinese Patent Application Serial No. 201810234679.9, filed with the State Intellectual Property Office of P. R. China on Mar. 21, 2018, the entire disclosure of which is incorporated herein by reference.

### FIELD

The present disclosure relates to a field of electronic technology, and more particularly to an electronic device and a manufacturing method for an electronic device.

### BACKGROUND

Generally, an electronic device such as a mobile phone includes elements such as a display screen and a light sensor, and the light sensor can be used for detecting ambient brightness around the electronic device. With the development of mobile phone technology and the needs of users, a full-screen mobile phone has become a development trend of mobile phones, but the position of sensors such as light sensors makes the screen-to-body ratio of mobile phones relatively small. Therefore, how to properly position the various sensors has become an urgent problem.

### SUMMARY

The embodiments of the present disclosure provide an electronic device and a manufacturing method for the electronic device.

The electronic device according to embodiments of the present disclosure includes:

a display screen including a first surface and a second surface opposite to the first surface, and the display screen including a display area and a non-display area surrounding the display area;

a light sensor arranged adjacent to the second surface and opposite to the display area; and

a light guiding element arranged adjacent to the light sensor, the light guiding element being configured to transmit ambient light, penetrating the non-display area from the first surface, to the light sensor. Another electronic device according to embodiments of the present disclosure includes:

a display screen, including a first surface and a second surface opposite to the first surface, and the display screen including a display area and a non-display area surrounding the display area; a light sensor arranged adjacent to the second surface and opposite to the display area; and a light guiding element arranged adjacent to the second surface, the light guiding element being configured to transmit light, penetrating the non-display area from the first surface, to the light sensor.

The manufacturing method for the electronic device according to embodiments of the present disclosure including following operations:

providing a display screen, the display screen including a display area and a non-display area surrounding the display area, and the display screen including a first surface and a second surface opposite to the first surface;

providing a light sensor and arranging the light sensor adjacent to the second surface and opposite to the display area; and

providing a light guiding element;

arranging the light guiding element adjacent to the second surface and enabling the light guiding element to guide the light, penetrating the non-display area from the first surface to the light sensor.

### BRIEF DESCRIPTION OF THE DRAWINGS

These and other aspects and advantages of embodiments of the present disclosure will become apparent and more readily appreciated from the following descriptions made with reference to the drawings, in which:

FIG. 1 is a perspective view of an electronic device according to embodiments of the present disclosure;

FIG. 2 is a plan view of an electronic device according to embodiments of the present disclosure;

FIG. 3 is a sectional view of the electronic device in FIG. 2 along direction;

FIG. 4 is a partial sectional view of an electronic device according to embodiments of the present disclosure;

FIG. 5 is a another partial sectional view of an electronic device according to embodiments of the present disclosure;

FIG. 6 is a plan view of an electronic device according to embodiments of the present disclosure;

FIG. 7 is another plan view of an electronic device according to embodiments of the present disclosure;

FIG. 8 is yet another plan view of an electronic device according to embodiments of the present disclosure;

FIG. 9 is a further plan view of an electronic device according to embodiments of the present disclosure;

FIG. 10 is a further plan view of an electronic device according to embodiments of the present disclosure;

FIG. 11 is a sectional view of an electronic device according to embodiments of the present disclosure;

FIG. 12 is a further plan view of an electronic device according to embodiments of the present disclosure;

FIG. 13 is a flow diagram of a manufacturing method of an electronic device according to the present disclosure;

FIG. 14 is a flow diagram of a manufacturing method of an electronic device according to the present disclosure.

Reference numerals for main elements: electronic device 100, cover plate 11, touch layer 12, display screen 13, upper surface 131, lower surface 132, display area 1311, non-display area 1312, first coating layer 14, second coating layer 15, infrared sensor 16, emitter 161, receiver 162, encapsulation body 163, buffer layer 17, metal sheet 18, housing 20, light blocking element 30, light sensor 40, light guiding element 50, light incident end 51, light exit end 52, vertical portion 53, horizontal portion 54, battery 110, main circuit board 120.

### DETAILED DESCRIPTION

Embodiments of the present disclosure will be described in detail and examples of the embodiments will be illustrated in the accompanying drawing. The same or similar elements and the elements having same or similar functions are denoted by like reference numerals throughout the descriptions. The embodiments described herein with reference to the drawings are explanatory, which aim to illustrate the present disclosure, but shall not be construed to limit the present disclosure.

Electronic apparatus such as a mobile phone or a tablet computer or the like usually detect a distance between the electronic apparatus and a user by having an infrared sensor installed. In the case of the mobile phone, the infrared sensor is provided in an upper area of the mobile phone. When the user makes a voice call or performs related operations, the mobile phone is close to the head, the infrared sensor feeds distance information back to a processor, and the processor executes corresponding instructions, such as turning off light of the display screen component. In related art, it is required to provide corresponding hole in a housing for emitting and receiving infrared light signal when the infrared sensor is provided in the electronic apparatus. With the development of electronic apparatus, people have higher and higher requirements for the appearance and operation experience of the mobile phone. The mobile phone has developed toward a trend of a full screen. An ultra-narrow bezel forms between the housing and a display screen assembly in the full-screen mobile phone. Since a width of the ultra-narrow bezel is too small, there may not be enough space to provide the hole, overall strength of the bezel is reduced even if the hole is provided, and then reliability of the electronic apparatus is relatively.

The embodiments of the present disclosure provide an electronic device and a manufacturing method for the electronic device.

The electronic device according to embodiments of the present disclosure includes:

a display screen including a first surface and a second surface opposite to the first surface, and the display screen including a display area and a non-display area surrounding the display area;

a light sensor arranged adjacent to the second surface and opposite to the display area; and

a light guiding element arranged adjacent to the light sensor, the light guiding element being configured to transmit ambient light, penetrating the non-display area from the first surface, to the light sensor.

Another electronic device according to embodiments of the present disclosure includes: a display screen, the display screen including a display area and a non-display area surrounding the display area, and the display screen including a first surface and a second surface opposite the first surface; a light sensor arranged adjacent to the second surface and opposite to the display area; a light guiding element arranged adjacent to the second surface, the light guiding element being configured to transmit light, penetrating the non-display area from the first surface, to the light sensor.

The manufacturing method for the electronic device according to embodiments of the present disclosure includes following operations:

providing a display screen, the display screen including a display area and a non-display area surrounding the display area, and the display screen including a first surface and a second surface opposite to the first surface;

providing a light sensor and arranging the light sensor adjacent to the second surface and opposite to the display area;

providing a light guiding element; and

arranging the light guiding element adjacent to the second surface and enabling the light guiding element to guide the light, penetrating the non-display area from the first surface, to the light sensor.

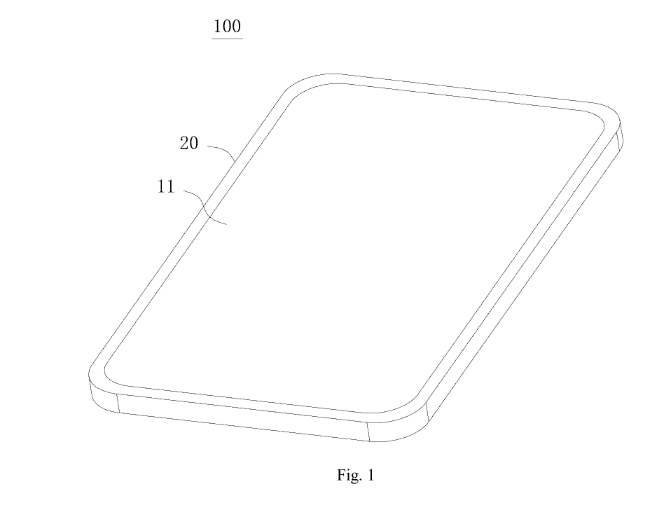

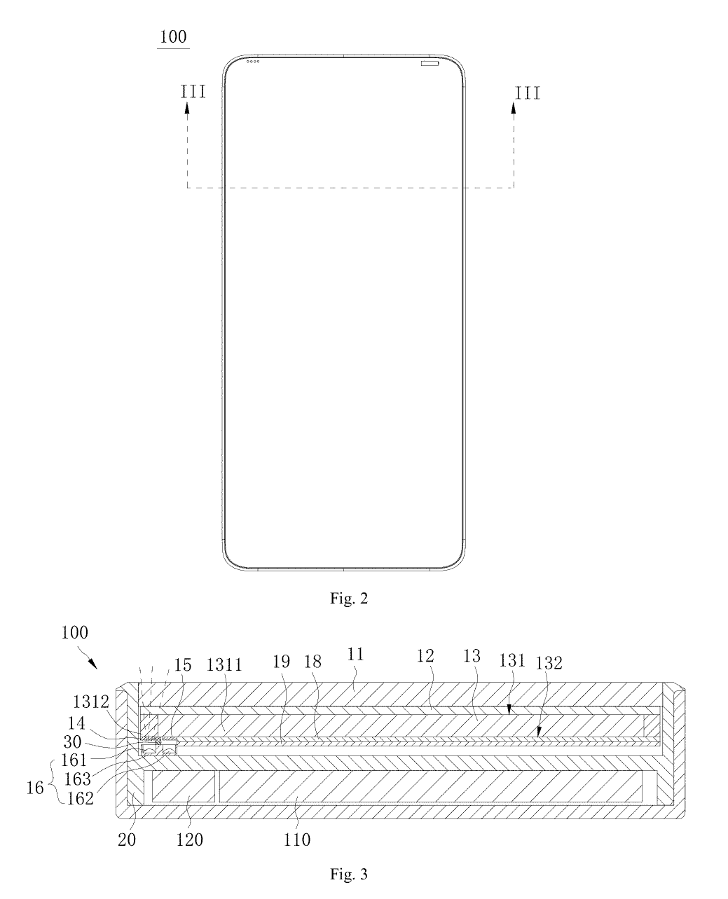

Referring to FIG. 1 and FIG. 2, embodiments of the present disclosure provide the electronic device 100 and a housing 20. The electronic device 100 can be a mobile phone or a tablet computer or the like. The electronic device 100 according to embodiments of the present disclosure is illustrated by taking the mobile phone as an example. Certainly, the electronic device 100 can also be other specific forms, which are not limited herein.

Referring to FIG. 3, the electronic device 100 includes a display screen 13, an infrared sensor 16 and a light blocking element 30. The display screen 13 includes a display area 1311 and a non-display area 1312, and the non-display area 1312 surrounds the display area 1311. The infrared sensor 16 is located below the display screen 13 and includes an emitter 161 and a receiver 162, and the emitter 161 is configured to emit infrared light. For example, the emitter 161 emits the infrared light through the non-display area 1312. The receiver 162 is configured to receive the infrared light. For example, the receiver 162 receives the infrared light through the display area 1311. The light blocking element 30 is disposed between the emitter 161 and the display area 1311, and the light blocking element 30 is configured to block the infrared light emitted from the emitter 161 from entering into the display area 1311.

It could be understood that the display screen 13 includes an upper surface 131 (as an example for a first surface of the display screen) and a lower surface 132 (as an example for a second surface of the display screen), and the display screen 13 is used for luminescence display through the upper surface 131. The display screen 13 is light permeable so that the infrared light emitted by the emitter 161 can penetrate the display screen 13, and similarly, the reflected infrared light can be received by the receiver 162 through the display screen 13.

The emitter 161 is configured to emit the infrared light. When the emitted infrared light meets barriers in a detection direction, a part of the infrared light is reflected back and received by the receiver 162. By calculating a time between the emission and return-by-reflection of the infrared light by means of a processor, a distance between the electronic device 100 and the barriers can be determined and adjusted. In an example, when a user answers or makes a call, the electronic device 100 approaches a head, the emitter 161 emits the infrared light, and the receiver 162 receives the infrared light reflected by the head, by calculating the time between the emission and return-by-reflection of the infrared light by means of the processor, corresponding commands are sent to control the backlight of the screen to be turned off. When the electronic device 100 is away from the head, the processor performs the calculation and sends commands according to the feedback data again, and the screen backlight is reopened. Thus, not only the user's misoperation is prevented, but also the power of the mobile phone is saved.

As the emitter 161 has a certain emission angle, even though the emitter 161 is located outside the display area 1311, it cannot be guaranteed that the infrared light emitted by the emitter 161 doesn't enter the display area 1311. Thus, the light blocking element 30 blocks the infrared light emitted by the emitter 161 from entering the display area 1311, preventing the infrared light from causing bad influence on photoelectric elements in the display area 1311. In an example, the light blocking element 30 is foam. Certainly, the light blocking element 30 can be other light proof material such as plastic.

In the electronic device 100, the receiver 162 servers as an input element of the electronic device 100. The receiver 162 can receive infrared signal and input the signal to the electronic device 100. The display screen 13 serves as an output element of the electronic device 100, the display screen 13 can output display content outside the display screen 13 so as to allow the user to obtain corresponding information.

The housing 20 is configured to accommodate the electronic device 100 so as to protect electronic device 100. By arranging the electronic device 100 in the housing 20, the electronic device 100 is surrounded by the housing 20, thus preventing outside factors from damaging inside elements of the electronic device 100 directly. The housing 20 can be formed by machining aluminum alloy by means of CNC machined tool, and can also be injection-molded with polycarbonate (PC) or PC+ABS material.

At mentioned above, in the electronic device 100 according to embodiments of the present disclosure, the display screen 13 allows the infrared sensor 16 to be arranged below the display screen 13 so as to guarantee full-screen effect of the electronic device 100. In addition, an orthographic projection of the emitter 161 of the infrared sensor 16 in the lower surface 132 of the display screen 13 is located outside the display area 1311 and the light blocking element 30 blocks the infrared light from entering the display area 1311, which can prevent the infrared light emitted by the emitter 161 from influencing operation stability of TFT of the display area 1311, so that the display screen 13 and the infrared sensor 16 can realize respective functions without interfering each other.

Specifically, the electronic device 100 further includes a battery 110 and a main circuit board 120. The battery 110 and the main circuit board 120 are disposed at a same side of the housing 20, and the battery 110 and the display screen 13 are disposed at two opposite sides of the housing 20. The battery 110 is used for providing electric energy for the electronic device 100, and the main circuit board 120 is configured to control operation state of the electronic device 100, for example, the main circuit board 120 controls the display screen 13 to play video content.

In some embodiments, the display screen 13 includes OLED screen.

Specifically, Organic Light-Emitting Diode (OLED) screen has better light transparency and is permeable to visible light and infrared light. Thus, the OLED screen does not affect the infrared sensor transmitting and receiving the infrared light while displaying content and effect. The display screen 13 can also adopt a Micro LED screen, and the Micro LED screen also has good light transmittance to the visible light and the infrared light. Certainly, these display screens are merely exemplary and the embodiments of the present disclosure are not limited thereto.

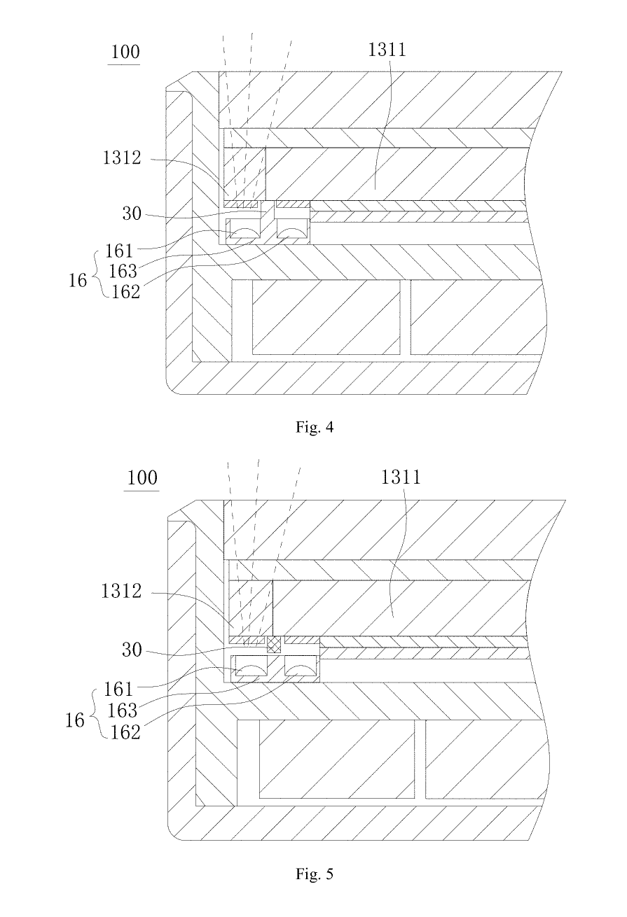

Referring to FIG. 4, in some embodiments, the light blocking element 30 is attached and fixed to a joint of the display area 1311 and the non-display area 1312. Thus, a fixed method of the light blocking element 30 can be achieved easily, so that the electronic device 100 can be manufactured easily. In an example, during the fixation of the light blocking element 30 to the lower surface 132 of the display screen 13, a double-sided tape can be attached to one surface of the light blocking element 30, and the light blocking element 30 is attached and fixed to the joint of the display area 1311 and the non-display area 1312 through the double-sided tape.

Referring to FIG. 3, in some embodiments, the infrared sensor 16 includes an encapsulation body 163 encapsulating the emitter 161 and the receiver 162. The light blocking element 30 is fixed to the encapsulation body 163 and located between the emitter 161 and the receiver 162. Thus, the light blocking element 30 is installed and fixed, which makes it convenient to integrate the infrared sensor 16 and the light blocking element 30 as a whole so as to be fitted with the display screen 13.

In some embodiments, the light blocking element 30 is soft material, and the light blocking element 30 is abutted against the lower surface 132. Thus, the light blocking element 30 has better light blocking effect, and it is guaranteed that the infrared light emitted by the emitter 161 cannot enter the display area 1311. In addition, it makes the infrared sensor 16 to be fitted with the display screen 13 in a more compact structure.

Referring to FIG. 5, in some embodiments, the light blocking element 30 and the encapsulation body 163 are integral structures. Thus, the light blocking element 30 can be made of same material as the encapsulation body 163, the light blocking element 30 can be formed while manufacturing the infrared sensor 16, which can reduce an amount of parts of the electronic device 100 so as to improve assembly efficiency of the electronic device 100.

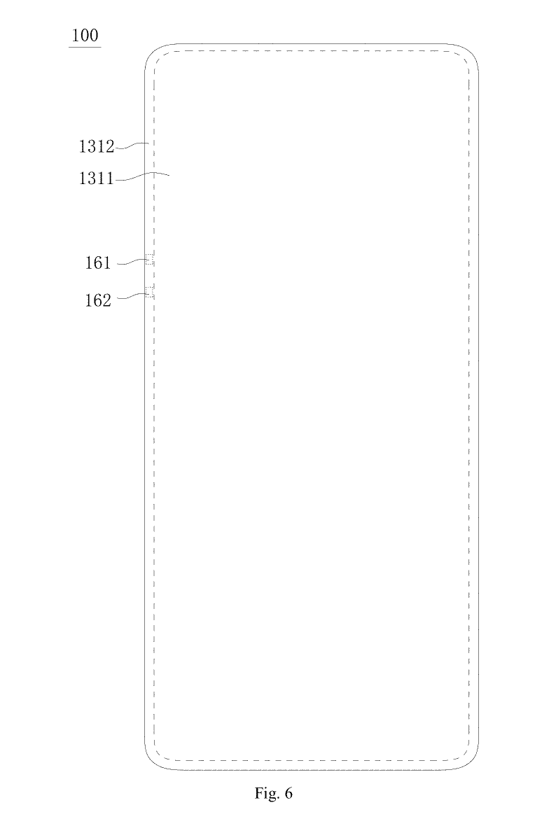

In some embodiments, an orthographic projection of the receiver 162 in the lower surface 132 is located in the display area 1311, and the receiver 162 is configured to receive the infrared light penetrating the display area 1311. Thus, there is enough space to arrange the receiver 162. Certainly, in some embodiments, the orthographic projection of the receiver 162 in the lower surface 132 can also be located at a position corresponding to the non-display area 1312, as illustrated in FIG. 6.

Referring to FIG. 3, in some embodiments, the electronic device 100 further includes a touch layer 12 and a cover plate 11. The cover plate 11 is formed on the touch layer 12, the touch layer 12 is disposed to the display screen 13, the upper surface 131 of the display screen 13 faces the touch layer 12, and the touch layer 12 and the cover plate 11 both have light transmittance to the visible light and the infrared light of more than 90%.

Specifically, the touch layer 12 is mainly used for receiving input signal generated when the user touches the touch layer 12 and transmitting the input signal to the circuit board for data processing, so as to obtain a specific position where the user touches the touch layer 12. The touch layer 12 can be attached to the display screen 13 by using In-Cell or On-Cell bonding technology, which can effectively reduce the weight of the display screen and reduce the overall thickness of the display screen. In addition, the cover plate 11 is disposed to the touch layer 12, which can effectively protect the touch layer 12 and its internal structures, preventing external forces from damaging the touch layer 12 and the display screen 13. The cover plate 11 and the touch layer 12 both have light transmittance to the visible light and the infrared light of more than 90%, which is not only beneficial for the display screen 13 to better display the content and effect, but also convenient for the infrared sensor 16 arranged below the display screen 13 to emit and receive the infrared light stably, guaranteeing the normal operation of the infrared sensor 16.

In some embodiments, the display screen 13 is used for luminescence display through the display area 1311, and an area ratio of the display area 1311 to the cover plate 11 is greater than 90%. For example, the area ratio of the display area 1311 to the cover plate 11 is values such as 95%, 96% or the like.

Specifically, by setting the ratio of the display area 1311 to the cover plate 11, when the cover plate 11 is attached to the display screen 13, the display area 1311 can display the content and effect with a larger size and area, which not only improves the user experience, but also effectively increase the screen-to-body-ratio of the electronic device 100, thus realizing full-screen effect. The non-display area 1312 can also be used to block other components and metal lines below the display screen 13, so that the appearance of the product remains consistent. The non-display area 1312 can enhance the optical density of the display screen 13 by printing ink, which also builds up good visual effect while ensuring the function of light blocking.

Referring to FIG. 3, in some embodiments, the electronic device 100 further includes a first coating layer 14, the first coating layer 14 is coated onto the lower surface 132 and covers the emitter 161. The first coating layer 14 is configured to be permeable to the infrared light and intercept visible light, and the emitter 161 is configured to emit the infrared light through the first coating layer 14.

Specifically, during the technique assembly, the installation of the emitter 161 usually requires assembling clearance to be reserved, which causes that a gap appears between the emitter 161 and other elements, the visible light enters through the gap, and light leak phenomenon appears. Thus, in a stack direction of the emitter 161 and the display screen 13, an area of an orthographic projection of the first coating layer 14 in the lower surface 132 covers an area of an orthographic projection of the emitter 161 in the lower surface 132, so that the first coating layer 14 can be allowed to fully block the emitter 161 without influencing the normal operation of the emitter 161, realizing the effect that the emitter 161 is invisible when the electronic device 100 is looked from outside.

The first coating layer 14 is permeable to the infrared light, so that when the emitter 161 emits the infrared light outside for detection, the infrared light has smaller intensity attenuation when penetrating the first coating layer 14, or the attenuation degree doesn't cause influence on the detection process, so that the normal operation of the emitter 161 is guaranteed. The first coating layer 14 intercepts the visible light to make the visible light to be not able to pass through the first coating layer 14, and the emitter 161 is blocked visually, thus realizing the effect that the emitter 161 is invisible when the electronic device 100 is looked outside.

In some embodiments, the infrared sensor 16 includes a proximity sensor, the emitter 161 is configured to emit the infrared light through the first coating layer 1311 and the non-display area 1312, and the receiver 162 is configured to receive the infrared light reflected by objects so as to detect a distance between the object and the upper surface 131.

Specifically, in an example, when the user answers or makes a call, the electronic device 100 approaches the head, the emitter 161 emits the infrared light, and the receiver 162 receives the infrared light reflected back, the processor calculates the time between the emission and return-by-reflection of the infrared light, and sends corresponding commands to control the backlight of the screen to be turned off. When the electronic device 100 is away from the head, the processor performs the calculation and sends commands according to the feedback data again, and the screen backlight is reopened. Thus, not only the user's misoperation is prevented, but also the power of the mobile phone is saved.

In some embodiments, the first coating layer 14 includes IR ink, the IR ink has a light transmittance to the infrared light of more than 85%, and a light transmittance to the visible light of less than 6%. The IR ink is permeable to the infrared light with a wave length of 850 nm-940 nm.

Specifically, as the IR ink has the characteristic of low light transmittance to the visible light, when the electronic device 100 is looked outside, the emitter 161 arranged below the first coating layer 14 cannot be viewed based on human eye vision. Meanwhile, the IR ink also has the characteristic of high light transmittance to the infrared light, so that the emitter 161 can emit the infrared light stably, guaranteeing the normal operation of the emitter 161.

Referring to FIG. 6, in some embodiments, the emitter 161 and the receiver 162 are separated structures.

Specifically, as the emitter 161 and the receiver 162 are separated structures, when arranging the emitter 161 and the receiver 162, the emitter 161 and the receiver 162 can be arranged compactly or dispersedly, which is not only beneficial for the electronic device 100 to distribute spatial position of each element sufficiently and apply the emitter 161 and the receiver 162 of various shapes, but also beneficial for the emitter 161 and the receiver 162 to spare possible positions for other elements of the electronic device 100.

In an example, the separated emitter 161 and receiver 162 are both disposed below a length edge of the non-display area 1312, as illustrated in FIG. 6.

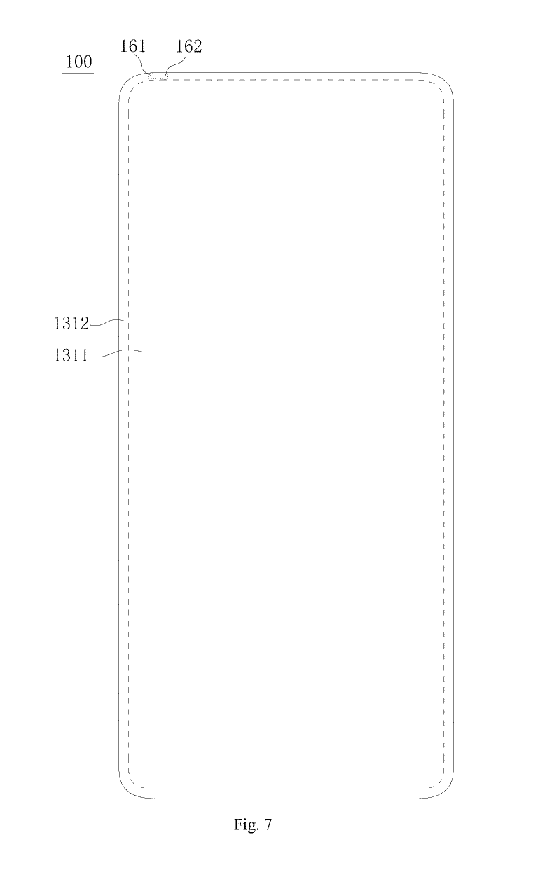

In another example, the separated emitter 161 and receiver 162 are both arrange below a position corresponding to a corner of the non-display area 1312, as illustrated in FIG. 7.

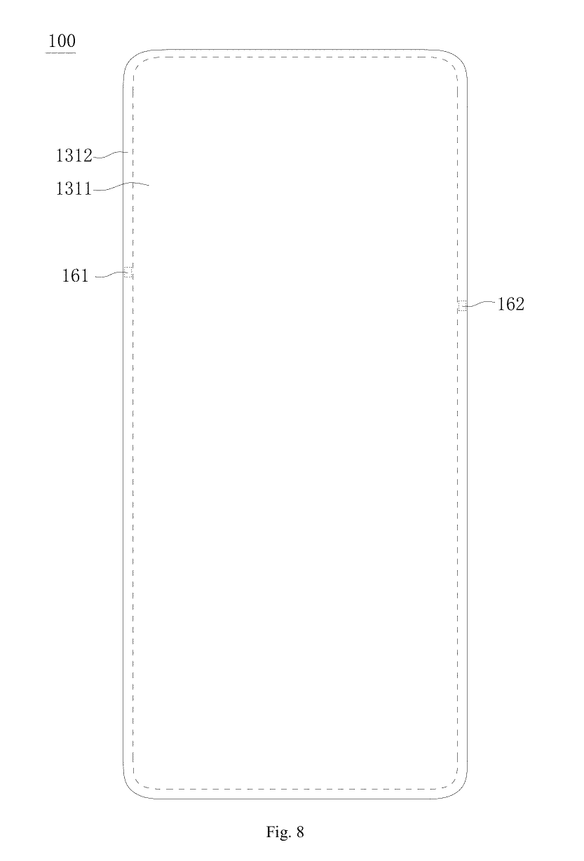

In yet another example, the separated emitter 161 and receiver 162 are arranged below two length edges of the non-display area 1312 respectively, as illustrated in FIG. 8.

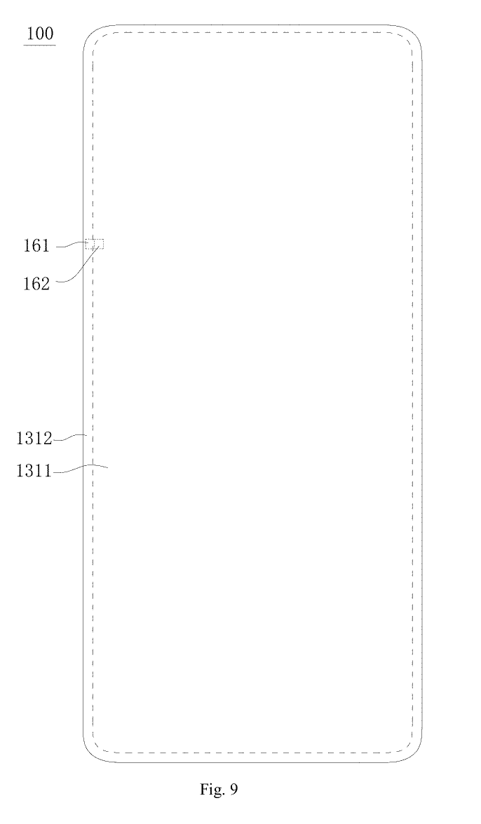

Referring to FIG. 9, in some embodiments, the emitter 161 and the receiver 162 are integral structures.

Specifically, the emitter 161 and the receiver 162 are integral structures, which can omit the line connection between the separated structures, which is beneficial to reduce the line technical process, improve the production efficiency of the product, and reduce the production cost.

In the example illustrated in FIG. 9, in the infrared sensor 16, the emitter 161 is located at a position corresponding to the non-display area 1312, and the receiver 162 is located at a position corresponding to the display area 1311.

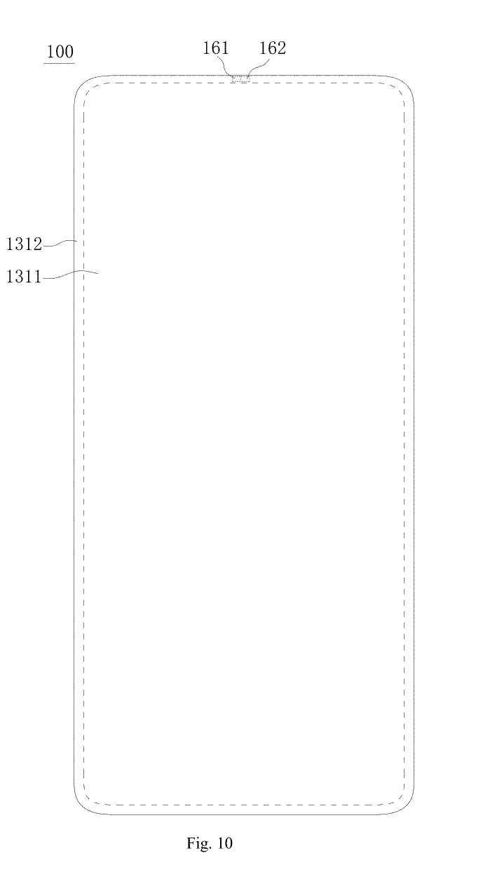

In the example in FIG. 10, the emitter 161 and the receiver 162 in integral structures are both disposed at a position corresponding to a width edge of the non-display area 1312.

Referring to FIG. 3 again, in some embodiments, the electronic device 100 further includes a second coating layer 15 being coated onto the lower surface 132 and covering the receiver 162, the second coating layer 15 is configured to be permeable to the infrared light and intercept the visible light, and the receiver 162 is configured to receive the infrared light through the display area 1311 and the second coating layer 15.

Specifically, during the technique assembly, the installation of the receiver 162 usually requires assembling clearance to be reserved, which causes that a gap appears between the receiver 162 and other elements, the visible light enters through the gap, and light leak phenomenon appears. Thus, in a stack direction of the receiver 162 and the display screen 13, an area of an orthographic projection of the second coating layer 15 in the lower surface 132 covers an area of an orthographic projection of the receiver 162 in the lower surface 132, so that the second coating layer 15 can be allowed to fully block the receiver 162 without influencing the normal operation of the receiver 162, realizing the effect that the receiver 162 is invisible when the electronic device 100 is looked from outside.

The second coating layer 15 can also adopt the IR ink. As the IR ink has the characteristic of the low light transmittance to the visible light, when the electronic device 100 is looked outside, the receiver 162 arranged below the second coating layer 15 cannot be viewed based on human eye vision. Meanwhile, the IR ink also has the characteristic of high light transmittance to the infrared light, so that the receiver 162 can receive the infrared light stably, guaranteeing the normal operation of the receiver 162.

In some embodiments, the electronic device 100 further includes a buffer layer 17 covering the lower surface 132 and avoiding the infrared sensor 16.

Specifically, the buffer layer 17 is used to mitigate impact and shock to protect the touch layer 12 and the display screen 13 and their internal structures, so as to prevent the display screen 13 from being damaged by being subject to external impact. The buffer layer 17 can be made of foam, or foam plastic or rubber or other soft material. Certainly, these cushioning materials are merely exemplary and the embodiments of the present disclosure are not limited thereto. In addition, the infrared sensor 16 is avoided when arranging the buffer layer 17 so as to prevent the buffer layer 17 from intercepting the signal reception by the infrared sensor 16, lest the infrared sensor 16 is affected in the process of receiving the infrared light.

In some embodiments, the electronic device 100 further includes a metal sheet 18 covering the buffer layer 17 and avoiding the infrared sensor 16.

Specifically, the metal sheet 18 is configured to shield electromagnetic interference and connect ground and has a function of diffusing temperature rise. The metal sheet 17 can be formed by cutting a metal material such as copper foil or aluminum foil. Certainly, these metal materials are merely exemplary and embodiments of the present disclosure are not limited thereto. In addition, the infrared sensor 16 is avoided when arranging the metal sheet 18 so as to prevent the metal sheet 18 from intercepting the signal reception by the infrared sensor 16, lest the infrared sensor 16 is affected in the process of receiving the infrared light.

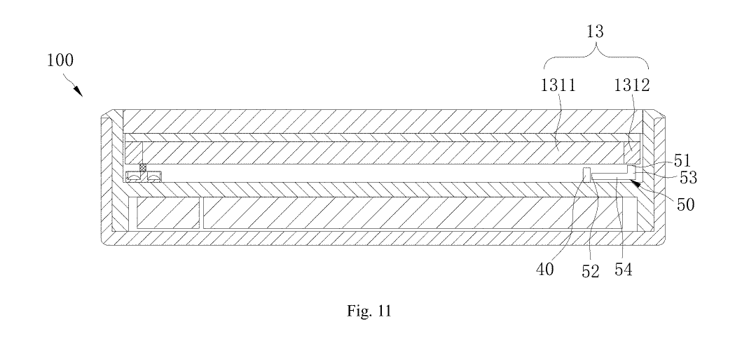

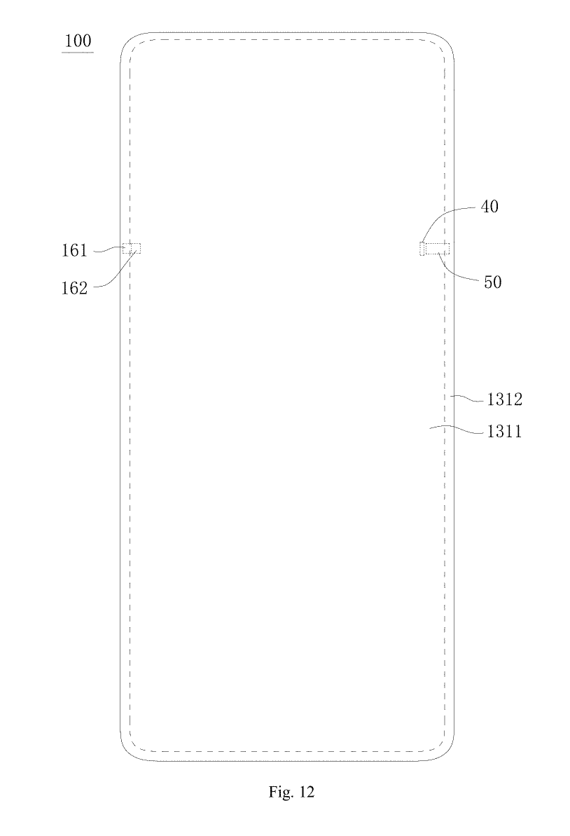

Referring to FIG. 11 and FIG. 12, in some embodiments, the electronic device 100 includes a light sensor 40 and a light guiding element 50, the light sensor 40 is disposed below the display area 1311, the light guiding element 50 is disposed below the display screen 13, and the light guiding element 50 is configured to guide the light penetrating the non-display area 1312 to the light sensor 40.

Thus, the light sensor 40 is arranged below the display area 1311 so as to ensure that the electronic device 100 realizes the full-screen effect. In addition, the light guiding element 50 guides the light to the light sensor 40 through the non-display area 1312, so that the light sensor 40 can sense and detect the ambient light intensity around the electronic device 100, thus preventing the light emitted from the display area 1311 from causing bad effect on the light sensor 40.

If the light sensor 40 is arranged below the display area 1311 and detects the ambient light intensity through the display area 1311, in this case, as a part of the light emitted from an organic light emitting layer of the display area 1311 is reflected downwards the display area 1311, the light sensor 40 detects the intensity of outside ambient light and intensity of the light generated by the display area 1311, so that the accuracy of the detection for the outside ambient light by the light sensor 40 is relatively low.

Specifically, the light guiding element 50 can be made of transparent light guiding material. For example, the material of the light guiding element 50 can be plastic or glass. The amount of the light guiding element 50 can be set according to specific requirements. For example, the amount of the light guiding element 50 can be one or two or the like. The light guiding element 50 includes a light incident end 51 and a light exit end 52, the light incident end 51 faces the non-display area 1312, the light exit end 52 faces the light sensor 40 so that the light guiding element 50 guides the visible light penetrating the non-display area 1312 to the light sensor 40.

When the light sensor 40 receives different light intensity, current of different intensity is generated so that the ambient light brightness is sensed. For example, when the user is in the sun, the ambient light is strong, the light sensor 40 feeds the ambient light intensity back to the processor, and the processor executes corresponding instructions to enhance the brightness of the display screen to adapt to the light intensity of the current environment, so that contents in the screen viewed by the user is more clear. When the user is in darker environment, the ambient light is weak, the light sensor 40 feeds the ambient light intensity back to the processor, and the processor executes corresponding instructions to lower the brightness of the display screen to adapt to the light intensity of in the current environment, so that the user does not feel glare when viewing the screen content, thus giving the user best visual effect. In this way, not only the user's vision is protected, but also the power of the mobile phone is saved and the function of further prolonging the service life of the battery is realized. Further, when the user uses the photographing function, the light sensor 40 can also be configured to adjust white balance.

In some embodiments, the light guiding element 50 includes a vertical portion 53 and a horizontal portion 54 connected with the vertical portion 53, the vertical portion 53 faces the non-display area 1312 directly, and the horizontal portion 54 bends towards the light sensor 40 at a bottom end of the vertical portion 53.

Thus, the light guiding element 50 forms substantially to be an L shape, so that the light sensor 40 can be arranged below the display area 1311 more easily. Certainly, in some embodiments, the light guiding element 50 can also form into other shapes such as an arc shape, as long as the light penetrating the non-display area 1312 can be guided to the light sensor 40.

In some embodiments, a light incident direction of the light guiding element 50 is perpendicular to the non-display area 1312, and/or a light exit direction of the light guiding element 50 is perpendicular to the light sensor 40.

That is, in some embodiments, the light incident direction of the light guiding element 50 is perpendicular to the non-display area 1312. Or, in some embodiments, the light exit direction of the light guiding element 50 is perpendicular to the light sensor 40. Or, in some embodiments, the light incident direction of the light guiding element 50 is perpendicular to the non-display area 1312 and the light exit direction of the light guiding element 50 is perpendicular to the light sensor 40.

Thus, most of the visible light penetrating the non-display area 1312 passes through the light guiding element 50 and reaches the light sensor 40, so that the accuracy for detecting the ambient light by means of the light sensor 40 is relatively high.

In some embodiments, a peripheral surface of the light guiding element 50 is coated with a black coating. Thus, it is possible to prevent the visible light from being emitted through the peripheral surface of the light guiding element 50 and the accuracy of the ambient light detection by the light sensor 40 is reduced.

In some embodiments, a light sensing face of the light sensor 40 is opposite to the display area 1311. Thus, it is possible to prevent the light sensor 40 from being subjected to the visible light emitted from the display area 1311 and causing a bed effect.

It is to be noted that the light sending face of the light sensor 40 being opposite to the display area 1311 means that an included angle between the light sensing face of the light sensor 40 and the lower surface of the display area 1311 is larger than or equal to 90 degree and less than or equal to 180 degree so as to prevent the light generated in the display area 1311 from being transmitted to the light sensing face of the light sensor 40.

In some embodiments, the light sensor 40 includes an ambient light sensor, the ambient light sensor is configured to sense ambient light, and the processor is configured to adjust brightness of the display screen according to light intensity sensed by the ambient light sensor.

Specifically, when the user is in the sun, the ambient light is strong, the ambient light receiver feeds the ambient light intensity back to the processor, and the processor executes corresponding instructions to enhance the brightness of the display screen to adapt to the light intensity of the current environment, so that contents in the screen viewed by the user is more clear. When the user is in darker environment, the ambient light is weak, the ambient light receiver feeds the ambient light intensity back to the processor, and the processor executes corresponding instructions to lower the brightness of the display screen to adapt to the light intensity of in the current environment, so that the user does not feel glare when viewing the screen content, thus giving the user best visual effect. In this way, not only the user's vision is protected, but also the power of the mobile phone is saved and the function of further prolonging the service life of the battery is realized.

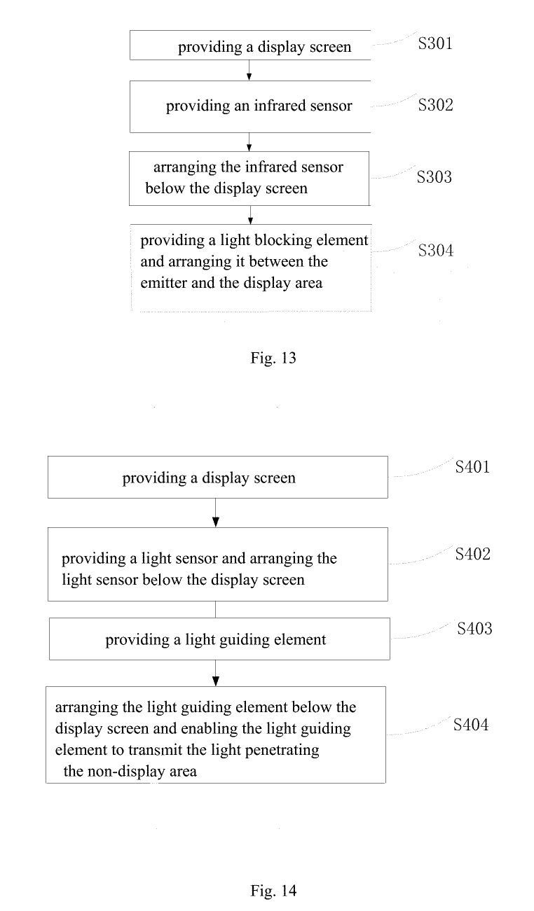

Referring to FIG. 3 and FIG. 13, embodiments of the present disclosure provide a manufacturing method for the electronic device 100, and the method includes the following operations at blocks S301 to S304.

At the block S301, a display screen 13 is provided. The display screen 13 includes a display area 1311 and a non-display area 1312 surrounding the display area.

At the block S302, an infrared sensor 16 is provided. The infrared sensor 16 includes an emitter 161 configured to emit infrared light and a receiver 162 configured to receive the infrared light.

At the block S303, the infrared sensor 16 is arranged below the display screen 13 so that the emitter 161 is located in the non-display area 1312.

At the block S304, a light blocking element 30 is provided and arranged between the emitter 161 and the display area 1311, and the light blocking element 30 is configured to block the infrared light emitted from the emitter 161 from entering the display area 1311.

Specifically, the electronic device 100 adopts the display screen 13, the infrared sensor 16 can be arranged below the display screen 13 in the case of the full-screen. In addition, it is possible to prevent the infrared light emitted from the emitter 161 from influencing operation stability of TFT of the display area 1311 by arranging the emitter 161 of the light sensor 16 in the non-display area 1312, so as to allow the display screen 13 and the infrared sensor 16 to realize their respective functions without interfering each other. The display screen 13 can be an Organic Light-Emitting Diode (OLED) screen, the OLED screen has better optical transparency and is permeable to visible light and infrared light. Thus, the OLED screen doesn't influence the infrared sensor in emitting and receiving the infrared light. The display screen 13 can also adopt the Micro LED screen, and the Micro LED screen also has good light transmittance to the visible light and the infrared light. Certainly, these display screens are merely exemplary and the embodiments of the present disclosure are not limited thereto. In addition, the upper surface 131 of the display screen 13 is configured to be permeable to visible light so as to display content and effect on one aspect, and to be permeable to the infrared light so as to allow the infrared sensor 16 to emit and receive the infrared light normally.

In some embodiments, the manufacturing method for the electronic device 100 further includes operations of providing the touch layer 12 to the display screen 13 and providing the cover plate 11 to the touch layer 12.

Specifically, the touch layer 12 is mainly used for receiving input signal generated when the user touches the touch layer 12 and transmitting the input signal to the circuit board for data processing, so as to obtain a specific position where the user touches the touch layer 12. The touch layer 12 can be attached to the display screen 13 by using In-Cell or On-Cell bonding technology, which can effectively reduce the weight of the display screen and reduce the overall thickness of the display screen. In addition, the cover plate 11 is disposed to the touch layer 12, which can protect the touch layer 12 and its internal structures, preventing external forces from damaging the touch layer 12 directly.

In some embodiments, before the operation at the block S303, the manufacturing method for the electronic device 100 further includes an operation of applying the lower surface 132 with the first coating layer 14.

Specifically, at the block S303, the infrared sensor 16 is arranged below the display screen 13 so as to enable the first coating layer 14 to cover the emitter 161, and the emitter 161 is configured to emit the infrared light through the first coating layer 14.

Specifically, the first coating layer 14 may adopt IR ink. As the IR ink has the characteristic of a low light transmittance to the visible light, when the electronic device 100 is looked outside, the emitter 161 arranged below the first coating layer 14 cannot be viewed based on human eye vision. Meanwhile, the IR ink also has the characteristic of high light transmittance to the infrared light, so that the emitter 161 can emit the infrared light stably, guaranteeing the normal operation of the emitter 161.

Referring to FIG. 11 and FIG. 14, in some embodiments, embodiments of the present disclosure provide a manufacturing method for the electronic device 100, which includes the following operations at blocks S401 to S404.

At the block S401, a display screen 13 is provided. The display screen 13 includes a display area 1311 and a non-display area 1312 surrounding the display area 1311.

At the block S402, a light sensor 40 is provided and the light sensor 40 is arranged below the display screen 13.

At the block S403, a light guiding element 50 is provided.

At the block S404, the light guiding element 50 is arranged below the display screen 13 and enabled to guide the light penetrating the non-display area 1312 to the light sensor 40.

In the present disclosure, unless specified or limited otherwise, a structure in which a first feature is “on” or “below” a second feature may include an embodiment in which the first feature is in direct contact with the second feature, and may also include an embodiment in which the first feature and the second feature are not in direct contact with each other, but are contacted via an additional feature formed therebetween. Furthermore, a first feature “on,” “above,” or “on top of” a second feature may include an embodiment in which the first feature is right or obliquely “on,” “above,” or “on top of” the second feature, or just means that the first feature is at a height higher than that of the second feature; while a first feature “below,” “under,” or “on bottom of” a second feature may include an embodiment in which the first feature is right or obliquely “below,” “under,” or “on bottom of” the second feature, or just means that the first feature is at a height lower than that of the second feature.

Various embodiments and examples are provided in the description to implement different structures of the present disclosure. In order to simplify the present disclosure, certain elements and settings will be described. However, these elements and settings are only by way of example and are not intended to limit the present disclosure. In addition, reference numerals may be repeated in different examples in the present disclosure. This repeating is for the purpose of simplification and clarity and does not refer to relations between different embodiments and/or settings. Furthermore, examples of different processes and materials are provided in the present disclosure. However, it would be appreciated by those skilled in the art that other processes and/or materials may be also applied.

In the specification, it is to be understood that terms such as “central,” “longitudinal,” “lateral,” “length,” “width,” “thickness,” “upper,” “lower,” “front,” “rear,” “left,” “right,” “vertical,” “horizontal,” “top,” “bottom,” “inner,” “outer,” “clockwise,” “counterclockwise,” “axial,” “radial,” and “circumferential” should be construed to refer to the orientation or position as then described or as illustrated in the drawings under discussion. These relative terms are for convenience of description, and do not indicate or imply that the device or element referred to must have a particular orientation or be constructed and operated in a particular orientation, and hence cannot be constructed to limit the present disclosure. In addition, terms such as “first” and “second” are used herein for purposes of description and are not intended to indicate or imply relative importance or significance or to imply the number of indicated technical features. Thus, the feature defined with “first” and “second” may comprise one or more of this feature. In the description of the present disclosure, “a plurality of” means two or more than two, unless specified otherwise. It should also be understood that, as used herein, the term “and/or” represents and contains any one and all possible combinations of one or more associated listed items.

In the description of the present disclosure, it should be understood that, unless specified or limited otherwise, the terms “mounted,” “connected,” and “coupled” and variations thereof are used broadly, and may be, for example, fixed connections, detachable connections, or integral connections; may also be mechanical or electrical connections; may also be direct connections or indirect connections via intervening structures; may also be inner communications of two elements, which can be understood by those skilled in the art according to specific situations.

Reference throughout this specification to “an embodiment,” “some embodiments,” “an illustrative embodiment,” “an example,” “a specific example,” or “some examples,” means that a particular feature, structure, material, or characteristic described in connection with the embodiment or example is included in at least one embodiment or example of the present disclosure. Thus, the appearances of the phrases such as “in some embodiments,” “in one embodiment”, “in an embodiment”, “in another example,” “in an example,” “in a specific example,” or “in some examples,” in various places throughout this specification are not necessarily referring to the same embodiment or example of the present disclosure. Furthermore, the particular features, structures, materials, or characteristics may be combined in any suitable manner in one or more embodiments or examples.

Although embodiments have been illustrated and described, it would be appreciated by those skilled in the art that changes, modifications, alternatives and variants can be made in the embodiments without departing from principles and purposes of the present disclosure. The protection scope of the present disclosure is defined by the claims or the like.

What is claimed is:

1. An electronic device, comprising:
a display screen comprising a first surface and a second surface opposite to the first surface, and the display screen comprising a display area and a non-display area surrounding the display area;
a light sensor arranged adjacent to the second surface and opposite to the display area; and
a light guiding element arranged adjacent to the light sensor, the light guiding element being configured to transmit ambient light, penetrating the non-display area from the first surface, to the light sensor.

2. The electronic device according to claim 1, wherein the light guiding element is formed into an L shape.

3. An electronic device, comprising:
a display screen comprising a first surface and a second surface opposite to the first surface, and the display screen comprising a display area and a non-display area surrounding the display area;
a light sensor arranged adjacent to the second surface and opposite to the display area; and
a light guiding element arranged adjacent to the second surface, the light guiding element being configured to transmit light, penetrating the non-display area from the first surface, to the light sensor.

4. The electronic device according to claim 3, wherein the light guiding element comprises a vertical portion and a horizontal portion connected with the vertical portion, the vertical portion is located opposite to the non-display area, and the horizontal portion bends from a bottom end of the vertical portion towards the light sensor.

5. The electronic device according to claim 3, wherein a light incident direction of the light guiding element is perpendicular to the non-display area, and/or a light exit direction of the light guiding element is perpendicular to the light sensor.

6. The electronic device according to claim 3, wherein a peripheral surface of the light guiding element is coated with a black coating.

7. The electronic device according to claim 3, wherein an included angle between a light sensing face of the light sensor and the second surface ranges from 90° to 180°.

8. The electronic device according to claim 3, further comprising a touch layer and a cover plate arranged on the touch layer, the touch layer being arranged between the display screen and the cover plate, and the touch layer and the cover plate both having light transmittance to visible light and infrared light of more than 90%.

9. The electronic device according to claim 8, wherein an area ratio of the display area to the cover plate is greater than 90%.

10. The electronic device according to claim 3, wherein the electronic device comprises an infrared sensor and a light blocking element, the infrared sensor comprises an emitter and a receiver, the emitter is located adjacent to the second surface and opposite to the non-display area, the emitter is configured to emit infrared light, and the receiver is configured to receive the infrared light;
wherein the light blocking element is arranged between the emitter and the display area, and the light blocking element is configured to block the infrared light emitted from the emitter from entering the display area.

11. The electronic device according to claim 10, wherein the infrared sensor comprises an encapsulation body encapsulating the emitter and the receiver, and the light blocking element is fixed to the encapsulation body and located between the emitter and the receiver.

12. The electronic device according to claim 11, wherein the light blocking element is abutted against the second surface

13. The electronic device according to claim 11, wherein the light blocking element and the encapsulation body form an integral structure.

14. The electronic device according to claim 10, further comprising a first coating layer, the first coating layer being coated on the second surface and covering the emitter, the first coating layer being configured to be permeable to the infrared light and intercept visible light, and the emitter being configured to emit the infrared light through the first coating layer.

15. The electronic device according to claim 14, wherein the infrared sensor is a proximity sensor, the emitter is configured to emit the infrared light through the first coating layer, and the receiver is configured to receive the infrared light reflected by an object so as to detect a distance between the object and the first surface.

16. The electronic device according to claim 10, further comprising a second coating layer being coated on the second surface and covering the receiver, the second coating layer being configured to be permeable to the infrared light and intercept visible light, and the receiver being configured to receive the infrared light through the display area and the second coating layer.

17. The electronic device according to claim 3, further comprising a buffer layer covering the second surface.

18. The electronic device according to claim 17, further comprising a metal sheet covering the buffer layer.

19. A manufacturing method for an electronic device, comprising following operations:
providing a display screen, the display screen comprising a display area and a non-display area surrounding the display area, and the display screen comprising a first surface and a second surface opposite to the first surface;
providing a light sensor and arranging the light sensor adjacent to the second surface and opposite to the display area; and
providing a light guiding element;
arranging the light guiding element adjacent to the second surface and enabling the light guiding element to guide light, penetrating the non-display area from the first surface, to the light sensor.

20. The manufacturing method for the electronic device according to claim 19, further comprising following operations:
providing an infrared sensor, the infrared sensor comprising an emitter configured to emit infrared light and a receiver configured to receive the infrared light, the emitter being located opposite to the non-display area; and
providing a light blocking element, locating the light blocking element between the emitter and the display area, the light blocking element being configured to prevent the infrared light emitted from the emitter from entering the display area.
